(19) United States
(12) Patent Application Publication
(10) Pub. No.: US 2006/0254070 A1
(43) Pub. Date: Nov. 16, 2006

(54) Rotational tape retraction and releasing structure for tape measure

(75) Inventor: Jason Huang, Taipei (TW)

Correspondence Address: BRUCE H. TROXELL, SUITE 1404, 5205 LEESBURG PIKE, FALLS CHURCH, VA, 22041, US

(73) Assignee: Index Measuring Tape Co., Ltd.

(21) Appl. No.: 11/126,164

(22) Filed: May 11, 2005

(51) Int. Cl. G01B 3/10

(52) U.S. Cl. 33/756

(57) ABSTRACT

A rotational tape retracting and releasing structure for tape measure is provided which has less rotational wearing and trouble, increased reliability of cooperative rotation, and an easier assembling and disassembling structure. The subject structure for tape measure is characterized in that: a set of planetary gears can be firmly kept inside a gear box and then presented from departing out of the housing, and a sub-rotary disc axis member and a take-up drive can be rotated together.

### BACKGROUND OF THE INVENTION

1. Field of the Invention

The present invention relates to a rotational tape retracting and releasing structure for tape measure, it takes up the tape quickly by using a planetary gear mechanism.

2. Description of the Prior Art

A conventional take up structure for tape measure is shown in FIG. 1, it comprises a front housing 10, a rear housing 11, a handle 12 and a capping plate 13. Wherein, the handle 12 and capping plate 13 are formed in one piece, the capping plate 13 is rotated between front housing 10 and rear housing 11, tape 14 is wound onto the surface of capping plate 13. The tap 14 is retracted or released when the handle 12 is rotated.

Such a conventional tape measure has the following disadvantages:
(1) Because of the structure described above, it is necessary to intentionally leave a gap between the capping plate and the handle, which would result in anyone of frictional wear; breakage in a narrow gap thereof; and mechanical trouble due to penetration of soil or dust in a broad gap thereof.
(2) Because of the structure described above, the rotation of tape drum is controlled by rotation of handle, while the rotation of handle is operated by hand. It then cannot have a quick measure.
(3) Because of the structure described above, if the handle is quickly rotated by hand, it is easier to cause harm to the user.

The applicant has been authorized by the patentee of U.S. Pat. No. 5,718,056 to use, manufacture and sell the product of the patent, and, after many years of producing, he find the mechanism of said patent has disadvantage that the gears would be separated and released from the rotational mechanism especially when the handle is rotated fast.

### SUMMARY OF THE INVENTION

Then, it is an object of the present invention to solve the problems described above of the conventional tape measure and to provide a novel tape measure.

An another object of the present invention is to provide a rotational tape retracting and releasing structure for tape measure, which includes: a main rotary disc axis member provided with a take-up handle fitted on an outside surface and a first short axis integrally formed in a center of an inside surface thereof and rotatably inserted into a layer bearing hole formed on an outer surface of the inward collar portion of the bearing member; and a sub-rotary disc axis member provided with a bearing hole in a center thereof and arranged opposingly to the main rotary disc axis member in the inward collar portion to fit the first short axis in the bearing hole, the sub-rotary disc axis member being rotatably fixed to the main rotary disc axis member by means of an anti-departing plate by screwing a third screw to an end surface of the first short axis, thereby forming gear box space surrounded by the main and sub-rotary disc axis, as well as the inward collar portion.

Because of the above-mentioned structure of the present invention, the sub-rotary disc axis member, which also functions as a conventional capping plate when the take-up handle is rotated, and the take-up drum is rotated together at a doubled velocity by means of the planetary gears. Accordingly, it is not necessary to intentionally leave a gap between the sub-rotary disc axis member and the take-up drum, such an improved structure of the present invention can prevent problems or rotational wearing caused by the penetration of soil or dust in the gap.

According to the rotational tape retracting and releasing structure for tape measure of the present invention, the take-up drum is rotated at a doubled velocity of the handle. Then the tape can be smoothly taken-up more quickly, this is another object of the present application.

According to the rotational tape retracting and releasing structure for tape measure of the present invention, the handle is rotated much more slowly than the take-up drum. It can prevent a damage and troublesome to people due to the rotation of handle in high velocity.

According to the rotational tape retracting and releasing structure for tape measure of the present invention, as the sub-rotary disc axis member and the take-up drum are connected by fitting the lateral convex portions and the oblong concave portion, complete cooperation of rotation thereof can be achieved by the above-mentioned structure. In addition, as the gear system is assembled as unit and the unit thus assembled is kept firmly inside a gear box by means of an anti-departing plate screwed onto the shafts of planetary gears, then the planetary gears can be prevented from departing out of the housing of tape measure, when the handle is rotated fast.

### BRIEF DESCRIPTION OF THE DRAWINGS

The above object and advantages of the present invention will become more apparent by describing in detail preferred embodiments thereof with reference to the attached drawings in which:

FIG. 1 is a cross-sectional view showing the rotational structure of conventional tape measure;

FIG. 2 is a perspective view showing the embodiment of a tape measure having the structure of present invention;

FIG. 3 is an exploded view showing the parts of present invention;

FIG. 4 is a plane view showing an arrangement of the gears in a bearing member of present invention;

FIG. 5 is a perspective view showing the structure between the take-up drum and a sub-rotary disc axis member of present invention;

FIG. 6 is a cross-sectional view showing the structure of present invention.

### DETAILED DESCRIPTION OF THE PREFERRED EMBODIMENT

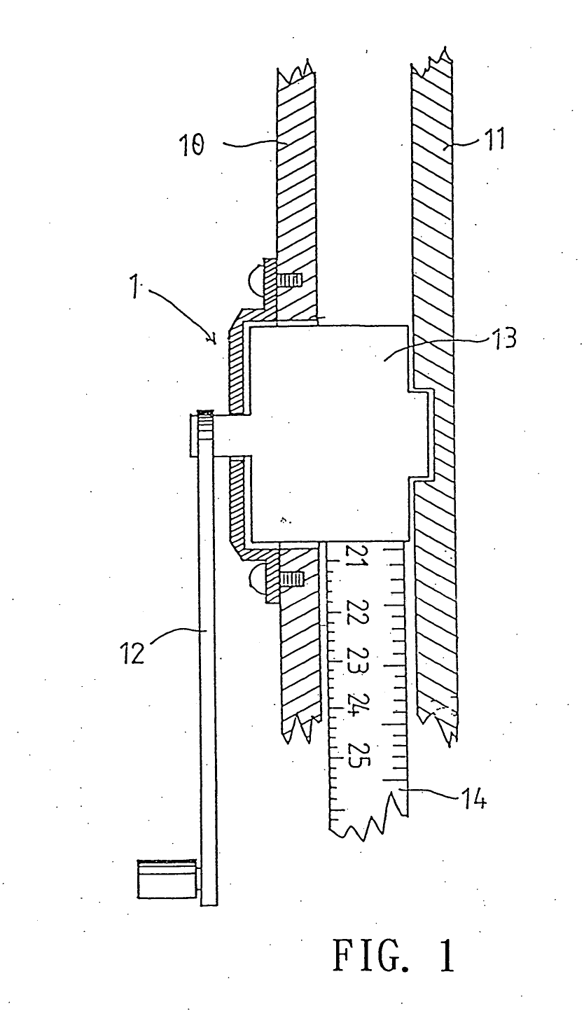

The structure of the conventional tape measure shown in FIG. 1, together with its disadvantages and stated above, it is not necessary to repeat here.

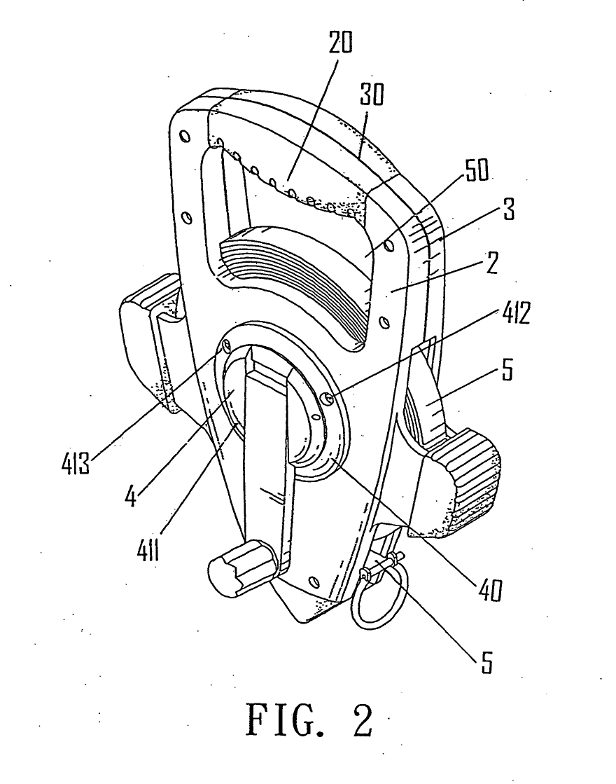

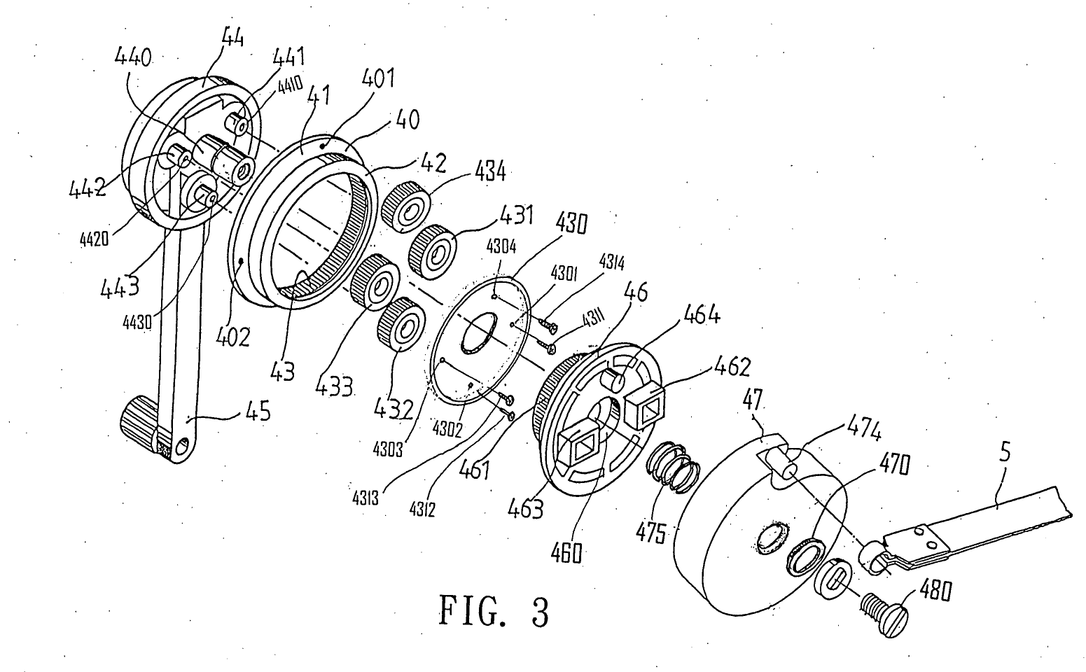

In the example shown in FIG. 2 and FIG. 3, it is shown that the present invention comprises:

a front housing 2 and rear housing 3 with a ring-like grip portion 20, 30 are made of rigid plastics;

a rotational mechanism 4 together with tape 5 are put inside the housing space between the front housing 2 and rear housing 3, after the front housing 2 and rear housing 3 are combined with each other, they are fixed buy means of screws.

At the central portion of front housing 2, there is a bearing supporting hole 21 with screw holes 211, 212, 213 on its periphery, such that a ring-like bearing member 40 can be fixed onto the front housing 2 by means of screws 411, 412, 413 being screwed into the fixing holes 401, 402 403 formed on the outer extended fitting flange 41 of ring-like bearing member 40.

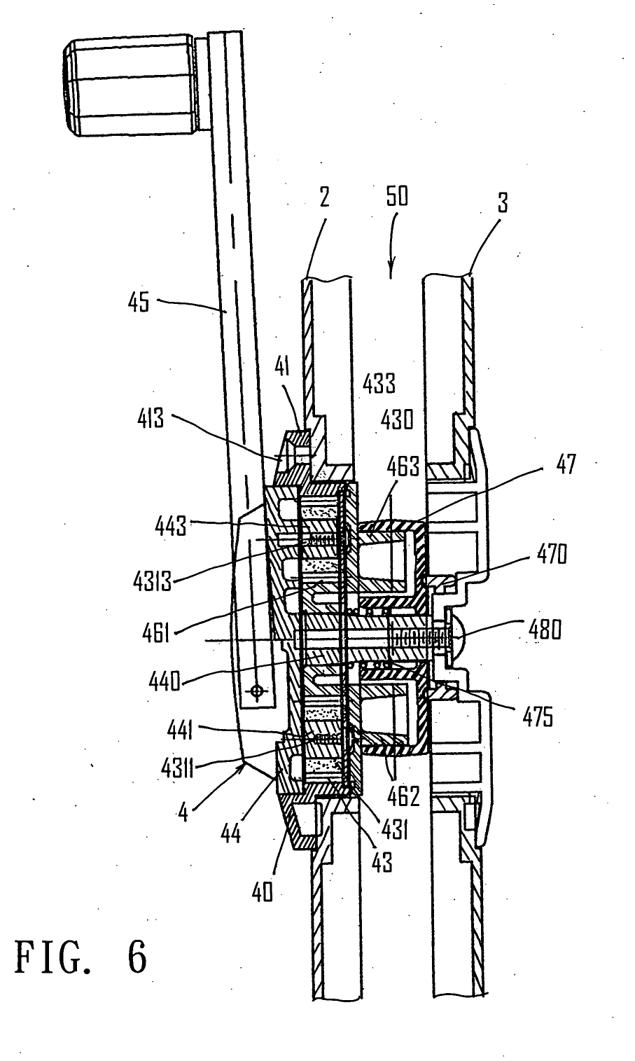

Please refer to FIG. 3, it is shown that on the inner surface of ring-like bearing member 40, a gear annulus 43 is formed, and a plurality of planetary gears 431, 432, 433, 434 are fitted with gear annulus 43 by means of pin-bearing axes 441, 442, 443, 444 integrally formed on a side surface of the main rotary disc axis member 44. On the another side surface of the main rotary disc axis member 44, a handle 45 is integrally formed. If the handle 45 is rotated, each of the planetary gears 431, 432, 433, 434 then rotates on the said gear annulus 43. At the central portion of the main rotary disc axis member 44, there is a long axis 440. Thus, the sub-rotary disc axis member 46 is rotatably fixed to the main rotary disc axis member 44 by mounting it onto the long axis 440 and fixing it by screw 480 from the outside of rear housing 31 (as shown in FIG. 6). One side surface of sub-rotary disc axis member 46 is formed of a sun gear 461. The planetary gears 431, 432, 433, 434 are intermeshed with the gear annulus 43 and the sun gear 461 to rotate. There is also a fixing hole 4410 (4420, 4430, 4440) formed on the top end of the each pin-bearing axes 441, 442, 443, 444. An anti-departing plate 430 having screw hole 4301, 4302, 4303, 4304 is then fixed onto the top end of the pin-bearing axes 441, 442, 443, 444 by screws 4311, 4312, 4313. 4314 to keep the planetary gears 431, 432, 433, 434 inside the ring-like bearing member 40 from being departed out of the ring-like bearing member 40, when it is rotated.

Please refer to FIG. 3 again and further to FIG. 5, on the another side surface of sub-rotary disc axis member 46, a plurality of separated lateral convex portions 462, 463 are formed across a center longitudinal axis of the main rotary disc axis member 44, while an oblong convex portion 471, 472 is formed on a side surface of the take-up drum 47 opposingly to the sub-rotary disc axis member 46. The take-up drum 47 has a pillar-shaped furrow 473, while the sub-rotary disc axis member 46 has a catch pin 464 mounted on a side surface close to a periphery thereof to allocate in the said pillar-shaped furrow 473. Such that the take-up drum 47 will rotate with sub-rotary disc axis member 44. There is a pin 474 for one end of tape 5 to be fixed onto and then enable tape 5 to be wound onto the side surface of take-up drum 47. And a central hole 460, 470 is formed at the central part of take-up drum 47 and sub-rotary disc axis member 46 respectively for the long axis 440 to pass through. Between said sub-rotary disc axis member 46 and said take-up drum 47, there is a spring 475.

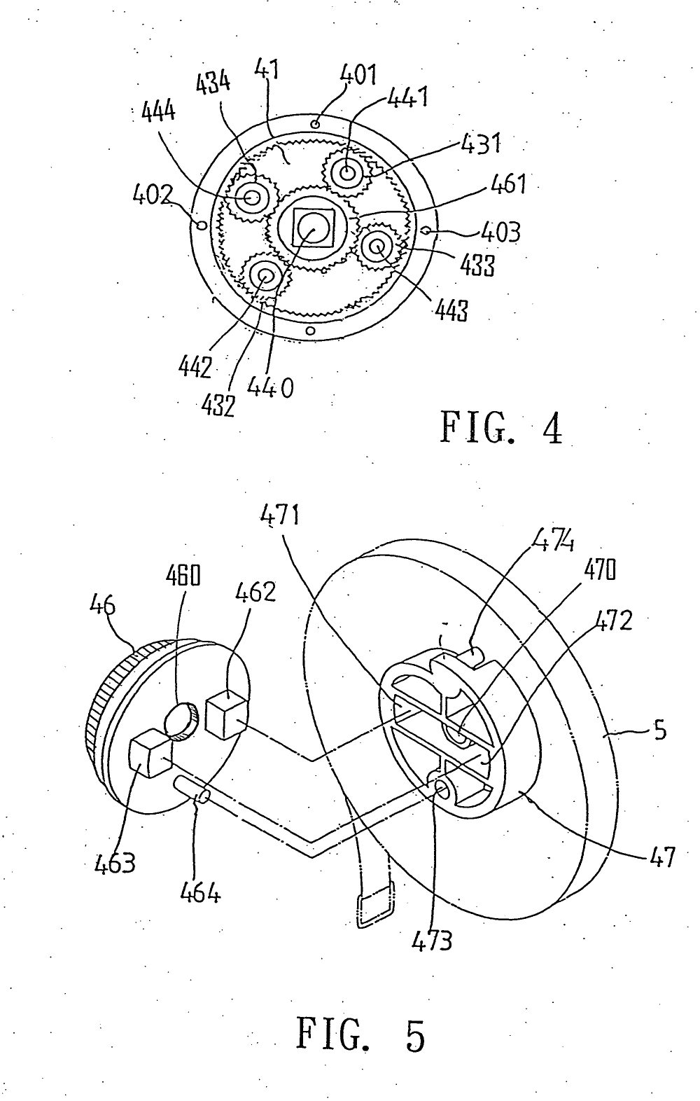

Please refer to FIG. 3, FIG. 4 and FIG. 5 again, in taking up the tape 5, rotate the handle 45, the main rotary disc axis member 44 then rotates accordingly. At this time, the planetary gears 431, 432, 433, 434 then rotate on the inner surface of gear annulus 43 of ring-like bearing member 40, the sun gear 461 and the take-up drum 47 then rotate simultaneously so as to take up the tape 5 and make the tape 5 be wound onto the take-up drum 47. When the handle 45 is rotated, since each of the planetary gears 431, 432, 433, 434 rotates by using the pin-bearing axes 441, 442, 443, 444 as its rotation shaft respectively. The rotational velocity of take-up drum 47 is higher than the rotational velocity of handle 45, due to the radius of gear annulus 43 is much larger than the radius of sun gear 461, and the rotational velocity of sun gear 461 is higher than that of gear annulus 43.

Because the anti-departing plate 430 is fixed outo the top end of the pin-bearing axes 441, 442, 443, 444 to keep the planetary gears 431, 432, 433, 434 inside the ring-like bearing member 40 from being departed out of the ring-like bearing member 40 when it is rotated, and the axis 440 formed at the central part of the ring-like bearing member 40 is long enough to pass through the central holes 460, 470 formed at the central portions of take-up drum 47 and sub-rotary disc axis member 46, then fixed to a screw 480 extended inside the rear housing 3 from the outside of rear housing 3. Therefore, the construction of present invention is much stronger than the U.S. Pat. No. 5,718,056 which is authorized to the applicant.

It is noted that the present invention is not limited to the preferred embodiment described above, and it is apparent that variations and modifications by those skilled in the art can be effected within the spirit and scope of the present invention defined in the appended claims.

What is claimed is:

1. A rotational tape retracting and releasing structure for tape measure, comprising:
A frame including a tape measure housing space thereof;
a ring-like bearing member formed independently of said frame and provided with an outer extended fitting flange and an inward collar having gear annulus formed on its inner peripheral edge portion, the ring-like bearing member being inserted into said bearing supporting hole from outside of said front housing so as to fit said fitting flange to an outer surface of a cut-end portion of said front housing by means of screws;
a main rotary disc axis member provided with a take-up handle fitted on an outside surface of said main rotary disc axis member and an axis integrally formed in a center of an inside surface of said main rotary disc axis member;
a sub-rotary disc axis member provided with a bearing hole in a center thereof and arranged opposingly to said main rotary disc axis member and in said inward collar portion to fit said short axis in said bearing hole of said sub-rotary disc axis member, said sub-rotary disc axis being rotatably fixed to said main rotary disc axis member by a screw screwed into an end surface of said short axes, thereby forming a gear box space surrounded by said main rotary disc axis member and said sub-rotary disc axis members as well as said inward collar portion; on one side surface of said sub-rotary disc axis member, there is a sun gear which is fitted with said gear formed on the annulus of said ring-like bearing member;
plural planetary gears fitted with gear annulus formed on said surface of ring-like bearing member, each of the planetary gears is respectively fitted with gear annulus by means of each of pin-bearing axes integrally formed on a side surface of the main rotary disc axis member; and
a take-up drum having tape thereon arranged between said sub-rotary disc axis member and said rear housing and provided with a axis integrally formed at a center of a side surface of said drum positioned opposingly to said rear housing;
by means of the gear annulus, the planetary gears and the sun gear, in retracting and releasing the tape, slowly rotate the handle will cause tape be quickly retracted into the frame or released out of the frame;
it is characterized in that: an anti-departing plate having a central hole is fixed onto the top end of said pin-bearing axes to keep said planetary gears inside said ring-like bearing member from being departed out of said ring-like bearing member.

2. A rotational tape retracting and releasing structure for tape measure as claimed in claim 1, wherein said axis formed in the center of the inside surface of said main rotary disc axis member passes through said anti-departing plate, said take-up drum, and said sub-rotary disc axis member, then fixed to a screw extended inside said rear housing from the outside of rear housing.

3. A rotational tape retracting and releasing structure for tape measure as claimed in claim 1, wherein a spring is inserted between said anti-departing plate and said take-up drum.

4. A rotational tape retracting and releasing structure for tape measure as claimed in claim 3, wherein said spring is inserted between said take-up drum and said sub-rotary disc axis member.
